(19) United States
(12) Patent Application Publication
(10) Pub. No.: US 2026/0273811 A1
(43) Pub. Date: Sep. 17, 2026

(54) BIODEGRADABLE PLASTIC HAVING EXCELLENT PROCESSABILITY AND MECHANICAL PROPERTIES, PLASTIC PRODUCT OBTAINED BY MOLDING THE SAME, AND METHOD FOR MANUFACTURING THE SAME

(71) Applicant: TheDay1Lab, Seoul (KR)

(72) Inventors: Seunghyun YOO, Seoul (KR); Youngjin KIM, Seoul (KR); Jubong LEE, Seoul (KR)

(21) Appl. No.: 18/873,793

(22) PCT Filed: Jul. 29, 2024
(86) PCT No.: PCT/KR2024/011025

§ 371 Date: Dec. 11, 2024

(30) Foreign Application Priority Data
Sep. 19, 2023 (KR) 10-2023-0124803

(51) Int. Cl. B29C 45/00; B29K 67/00; B29K 309/00; B29L 7/00; C08K 3/26; C08K 5/053; C08L 3/04; C08L 67/04

(52) U.S. Cl. CPC B29C 45/0001; C08K 3/26; C08K 5/053; C08L 3/04; C08L 67/04; B29K 2003/00; B29K 2067/006; B29K 2067/046; B29K 2309/00; B29L 2007/008; C08K 2003/265; C08L 2201/06; C08L 2203/16; C08L 2205/02; C08L 2205/08

(57) ABSTRACT

The present invention relates to a biodegradable plastic having excellent processability and mechanical properties, a plastic product obtained by molding the same, and a method for manufacturing the same, and specifically to, a biodegradable plastic having excellent processability and mechanical properties, a plastic product obtained by molding the same, and a method for manufacturing the same, wherein the biodegradable plastic includes thermoplastic starch, thereby having excellent biodegradability as well as excellent molding processability and mechanical properties, and also has an environment-friendly manufacturing process.

### TECHNICAL FIELD

The present invention relates to a biodegradable plastic having excellent processability and mechanical properties, a plastic product obtained by molding the same, and a method for manufacturing the same, and specifically to, a biodegradable plastic having excellent processability and mechanical properties, a plastic product obtained by molding the same, and a method for manufacturing the same, wherein the biodegradable plastic includes thermoplastic starch, thereby having excellent biodegradability as well as excellent molding processability and mechanical properties, and also has an environment-friendly manufacturing process.

### BACKGROUND ART

Plastics including polymer materials are widely used in various fields due to easy manufacturing, widely-controllable physical properties, and easy molding processing. Such plastics rarely decompose in natural environments, so that plastic waste is one of the main causes of environmental destruction.

In recent years, economic policies of major countries have focused on reducing carbon emission to prevent global warming for sustainable growth, and increasing the use of renewable energy, and there is a growing consensus in international treaties reflecting the policies. Preventing environmental destruction by recycling plastics or allowing the plastics to decompose under natural conditions is also in line with the above-described trend.

Typical biodegradable plastics have been developed mainly from polyesters which are biodegradable under composting conditions or soil conditions. However, in order to prepare biodegradable polymers such as polylactic acid and polybutylene adipate terephthalate, a process of extracting monomers from natural polymers or in a petrochemical manner and then biochemically converting or polymerizing the monomers is required. Since carbon is emitted during the above-described process, there is still a burden on the environment. Therefore, research and development for reducing carbon emitted during such a manufacturing process is also required. As a result, there is a growing interest in a method for manufacturing biodegradable plastics, the method capable of reducing carbon emission during a manufacturing process by using natural polymers.

However, natural polymers tend to lack mechanical properties compared to synthetic plastics, and have a problem of poor processability, so that there is a need to develop a method for manufacturing biodegradable plastics, the method capable of reducing carbon emission during a manufacturing process while minimizing deterioration in mechanical properties.

### DISCLOSURE OF THE INVENTION

### Technical Problem

The present invention has been devised to solve the above-described technical limitations, and an objective to be achieved by the present invention is to provide an eco-friendly biodegradable plastic including starch, which is a natural polymer, thereby being able to be manufactured in an eco-friendly manner and having excellent processability, wherein the manufactured plastic has the same level of physical properties as a typical biodegradable plastic.

Other objects, specific advantages, and novel features of the present invention will become more apparent from the following detailed description and preferred embodiments in connection with the accompanying drawings.

### Technical Solution

In order to achieve the above-described technical objective, the present invention provides a biodegradable plastic including a thermoplastic starch composition and a biodegradable polymer resin, and satisfying Relation Equation 1 below.

$$0.01 \leq FC / V \leq 0.06 \qquad [ Relation Equation 1 ]$$

In Relation Equation 1 above, FC/V is obtained from FC and V values obtained in accordance with the following measurement method.

### [Measurement Method]

A sample of the biodegradable plastic is heated to 105° C. in a nitrogen atmosphere by a thermogravimetric analysis (TGA) method in accordance with criteria of ASTM D 7582-15, followed by maintaining the isothermal temperature for 10 minutes (Step 1), and the sample is heated for the second time to 800° C. while the nitrogen atmosphere is maintained, followed by maintaining the isothermal temperature at 800° C. for 10 minutes (Step 2), and then the nitrogen atmosphere is switched to an air atmosphere to burn the remaining biodegradable plastic sample (Step 3), wherein when the mass loss in each step is measured, the mass loss at Step 2 is referred to as V, and the mass loss at Step 3 is referred to as FC.

In a preferred embodiment of the present invention, the biodegradable plastic may include a thermoplastic starch composition in an amount of 10 wt % to 75 wt %.

In a preferred embodiment of the present invention, the thermoplastic starch composition may include starch, a plasticizer, and an additive.

In a preferred embodiment of the present invention, the additive may include a filler, an antioxidant, and natural substance-derived polymers other than the starch.

In a preferred embodiment of the present invention, the biodegradable polymer resin may include one or more selected from the group consisting of polylactic acid (PLA), polybutylene adipate terephthalate (PBAT), polybutylene succinate (PBS), and polyhydroxy alkanoates (PHAs).

In a preferred embodiment of the present invention, the biodegradable polymer resin may further include, as a compatibilizer, one or more biodegradable polymer resins selected from PLA, PBAT, PBS, and PHAs, which are grafted with a cyclic unsaturated anhydride or an unsaturated multifunctional carboxylic acid.

In a preferred embodiment of the present invention, the biodegradable plastic may further satisfy Relation Equations 2 and 3 below.

$$1. ( \% ) \leq {X}_{c} \leq 30. ( \% ) \qquad [ Relation Equation 2 ]$$

$$150 \leq {X}_{c} / ( FC / V ) \leq 750 \qquad [ Relation Equation 3 ]$$

In Relation Equations 2 and 3 above, FC/V is the same as defined in Relation Equation 1 above, and X_{c} represents crystallinity of the biodegradable plastic.

The present invention also provides a biodegradable plastic article manufactured by molding the above-described biodegradable plastic.

In a preferred embodiment of the present invention, the biodegradable plastic article may be a biodegradable film or plastic injection molded body.

### Advantageous Effects

A biodegradable plastic according to the present invention may be manufactured by an eco-friendly method, has excellent processability, and has physical properties suitable for use for practical purposes. Therefore, the biodegradable plastic according to the present invention may significantly reduce burdens on the environment during manufacturing and disposal processes, and may be usefully used in various areas such as films, containers, and injection molded bodies.

### BRIEF DESCRIPTION OF THE DRAWINGS

FIG. 1 is a graph showing a change in the weight of a biodegradable plastic with sample temperature when thermogravimetric analysis is performed on a biodegradable plastic according to a preferred embodiment of the present invention.

FIG. 2 illustrates an XRD spectrum (orange) of a biodegradable plastic according to a preferred embodiment of the present invention and a spectrum (blue) obtained by removing a background noise from the spectrum through a data program.

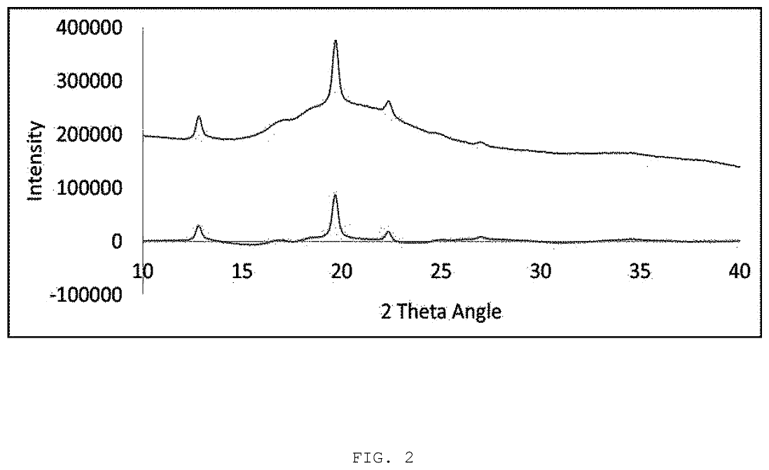

### MODE FOR CARRYING OUT THE INVENTION

Prior to a detailed description of compositions and effects of the present invention, the meanings of terms used in the present specification will be defined.

As used herein, the term “thermoplastic starch (TPS)” refers to a mixture in which starch extracted from grains such as rice, barley, soybeans, corn, sweet potatoes, and mung beans is mixed with excess water and a plasticizer at a temperature equal to or higher than a gelatinization temperature of the starch. The term “thermoplastic starch composition” refers to a composition including starch and a plasticizer.

Hereinafter, each composition of the present invention and effects thereof will be described in more detail.

### 1. Biodegradable Plastic

An embodiment of the present invention provides a biodegradable plastic, which is eco-friendly and has improved processability, by appropriately selecting a thermoplastic starch composition and a biodegradable polymer resin and combining the two in a specific content.

The biodegradable plastic satisfies Relation Equation 1 below, and accordingly, may have sufficient processability during the manufacturing thereof, and may have mechanical properties suitable for use in biodegradable vinyl or various plastic products.

$$0.01 \leq FC / V \leq 0.06 \qquad [ Relation Equation 1 ]$$

In Relation Equation 1 above, FC/V is obtained from FC and V values obtained in accordance with Measurement Method 1 below.

### [Measurement Method 1]

A sample of the biodegradable plastic is heated to 105° C. in a nitrogen atmosphere by a thermogravimetric analysis (TGA) method in accordance with criteria of ASTM D 7582-15, followed by maintaining the isothermal temperature for 10 minutes (Step 1), and the sample is heated for the second time to 800° C. while the nitrogen atmosphere is maintained, followed by maintaining the isothermal temperature at 800° C. for 10 minutes (Step 2), and then the nitrogen atmosphere is switched to an air atmosphere to burn the remaining biodegradable plastic sample (Step 3), wherein when the mass loss in each step is measured, the mass loss at Step 2 is referred to as V, and the mass loss at Step 3 is referred to as FC.

Relation Equation 1 above is for analyzing a biodegradable plastic by a proximate analysis method used to evaluate and understand the composition of biodegradable plastics, and it is quantified to identify chemical properties of the biodegradable plastic.

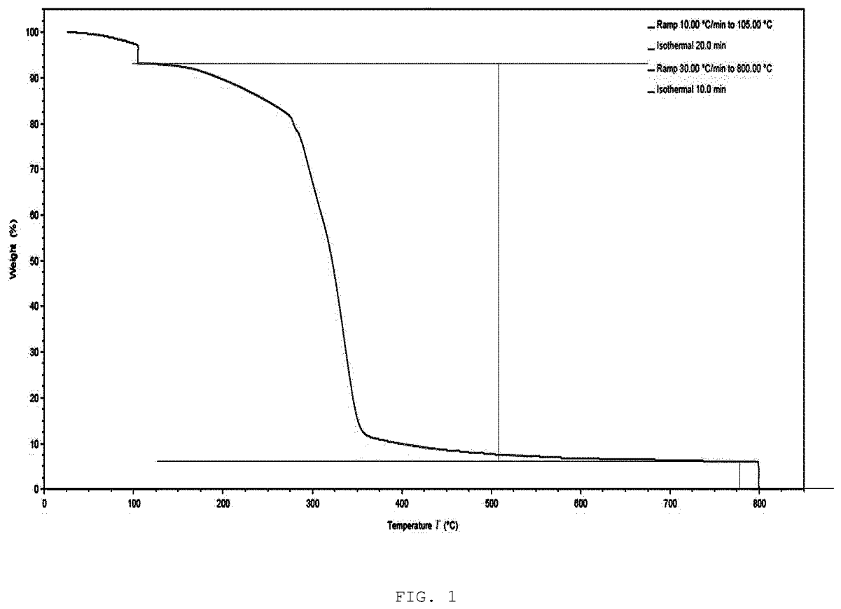

FIG. 1 shows a curve obtained by analyzing a biodegradable plastic with a thermogravimetric analyzer according to Measurement Method 1 above. Referring to FIG. 1, a sharp reduction in weight near 105° C. corresponds to Step 1 of the above measurement method, and the reduced weight corresponds to the weight of residual water. This is because the temperature of the sample increased to 100° C. or higher, which is the boiling point of water, and thus, water evaporated, thereby reducing the total weight by the weight of the evaporated water. In addition, during the raising of the temperature to about 800° C., the weight of the sample was continuously reduced, which corresponds to Step 2 of the above measurement method, and the weight reduced up to 800° C. corresponds to a weight V of entire volatile substances contained in the plastic sample. If the weight is no longer reduced even when the isothermal temperature is maintained at 800° C. for 10 minutes, most of the volatile substances have been removed, so that the atmosphere is switched to an air atmosphere by Step 3 to burn the remaining residue, thereby causing a weight reduction at 800° C. The reduction in weight according to Step 3 is a weight FC corresponding to fixed carbon, and FC/V in Relation Equation 1 above relates to an FC/V value obtained by performing thermogravimetric analysis on the biodegradable plastic sample through the above-described process.

If the FC/V value is smaller than 0.01, the content of a thermoplastic starch composition becomes too low, and the melt flow index (MFI) increases, thereby injection improving moldability and processability, but there is a problem in that the elongation of a manufactured biodegradable plastic decreases. On the contrary, if the FC/V value is larger than 0.06, the content of the thermoplastic starch composition becomes too high, and the melt flow index decreases, so that there may be a problem in that product molding processability becomes poor.

In addition, the biodegradable plastic according to a preferred embodiment of the present invention may further satisfy Relation Equations 2 and 3 below.

$$1. ( \% ) \leq {X}_{c} \leq 30. ( \% ) \qquad [ Relation Equation 2 ]$$

$$150 \leq {X}_{c} / ( FC / V ) \leq 750 \qquad [ Relation Equation 3 ]$$

In Relation Equations 2 and 3 above, FC/V is the same as defined in Relation Equation 1 above, and X_{c} represents crystallinity of the biodegradable plastic.

The crystallinity of the biodegradable plastic according to Relation Equations 2 and 3 above may be measured by Measurement Method 2 below.

### [Measurement Method 2]

An XRD spectrum of the biodegradable plastic sample is obtained in a range of 10° to 40° 20, and a background noise is removed therefrom. A ratio X_{c} of a peak area of a portion corresponding to a crystal region in the entire area of the XRD spectrum from which the background noise has been removed is calculated to obtain the crystallinity.

If the crystallinity according to Relation Equation 2 is less than 1.00%, there may be a problem in that the melt flow index of the biodegradable plastic excessively increases and the elongation decreases. On the contrary, if greater than 30.00%, there may be a problem in that the tensile strength and the elastic modulus excessively decrease.

In a preferred embodiment of the present invention, the biodegradable plastic may include a thermoplastic starch composition in an amount of 10 wt % to 75 wt %. If the content of the thermoplastic starch composition is less than 10 wt %, there is a problem in that the effect on reducing carbon emission during a manufacturing process is not significant, and the elongation of the biodegradable plastic decreases, and on the contrary, if the content of the thermoplastic starch composition is greater than 75 wt %, the melt flow index of the biodegradable plastic decreases, so that the molding processability may become poor, and mechanical properties of the biodegradable plastic, such as tensile strength and elastic modulus, may be degraded.

Preferably, in the case of manufacturing the biodegradable plastic into a biodegradable film with excellent elongation and then manufacturing the film into plastic articles such as packaging materials, wraps, and coating films, the thermoplastic starch composition may be included in an amount of 30 wt % to 75 wt % based on the total weight of the biodegradable plastic.

In addition, preferably, in the case of manufacturing the biodegradable plastic into an injection molded body with a high tensile strength or elastic modulus and then using the molded body as a structural body utilizing strength, the thermoplastic starch composition may be included in an amount of 10 wt % to 40 wt % based on the total weight of the biodegradable plastic.

The biodegradable plastic according to the present invention may be manufactured by compounding and extruding the above-described raw materials, the thermoplastic starch composition and the biodegradable polymer resin, and cutting a resulting product into pellets or chips. The biodegradable plastic may be manufactured into an article of a desired shape through post-processing, and has an advantage of having excellent processability during the post-processing.

A 2-step extrusion process or a 1-step extrusion process may be used to manufacture the biodegradable plastic by using the above-described raw materials. The 2-step extrusion process is a method performed by two times of extrusion. Specifically, if, selectively, an additive is physically mixed with starch and a plasticizer by using a mixer, a thermoplastic starch composition is formed, and the thermoplastic starch composition may be primarily extruded through a twin-screw extruder and pelletized to prepare thermoplastic starch pellets. Secondarily, the thermoplastic starch pellets may be mixed with the biodegradable polymer resin (including a compatibilizer) and secondarily compounded and extruded through a twin-screw extruder again and pelletized to be manufactured into a biodegradable plastic.

The 1-step extrusion process is a method in which a thermoplastic starch composition and a biodegradable polymer resin are simultaneously injected into a twin-screw extruder, compounded, and extruded to be manufactured into a biodegradable plastics, instead of preparing thermoplastic starch pellets by extrusion-molding the thermoplastic starch composition. In the 1-step extrusion process, a biodegradable plastic may be manufactured using only one time of extrusion.

### 2. Thermoplastic Starch Composition

The biodegradable plastic according to the present invention includes a thermoplastic starch composition, and thus, may obtain raw materials of biodegradable plastics from natural materials such as grains, and may reduce carbon emission during the manufacturing process. In addition, since the biodegradable plastic includes the thermoplastic starch composition, the elongation of the biodegradable plastic is improved to increase the utilization as a material requiring flexibility.

In a preferred embodiment of the present invention, the thermoplastic starch composition may include starch, a plasticizer, and an additive.

### Starch

In a preferred embodiment of the present invention, the thermoplastic starch composition may include the starch in an amount of 50 wt % to 70 wt %. A raw material for the starch include, but is not limited to, corn (Zea mays L.), cassava (Manihot esculenta), potato (Solanum tuberosum), sweet potato (Ipomoea batatas), mung bean (Vigna radiata), rice (Oryza sativa), barley (Hordeum vulgare), wheat (Hordeum vulgare), and the like. Alternatively, as the raw material for the starch, by-products produced in the food industry may be used.

Depending on the type of the raw material thereof, the starch may have different ratios of amylose and amylopectin. If the ratio of amylose is high, a biodegradable plastic tends to be low in elongation and high in tensile strength and elastic modulus. On the contrary, if the ratio of amylopectin is high, a biodegradable plastic low in tensile strength and elastic modulus but high in elongation may be manufactured. In addition, when the manufactured biodegradable plastic is stored, if the ratio of amylopectin is high, the biodegradable plastic absorbs moisture from the air, causing greater deterioration in the physical properties.

In general, amylose and amylopectin are included at a weight ratio of 20:80 to 30:70 in starch. Preferably, starch in which amylose is contained in an amount of 25 wt % to 30 wt % may be used.

If the content of the starch is less than 50 wt % of the thermoplastic starch composition, there may be a problem in that mechanical properties of a manufactured biodegradable plastic are degraded, and if greater than 70 wt %, molding processability of the biodegradable plastic may be poor.

### Plasticizer

The plasticizer is added to improve processability of the starch, and if the content of the plasticizer is insufficient, it may be difficult to mold a biodegradable plastic into a desired shape. On the contrary, if the content of the plasticizer is excessive, mechanical properties of a manufactured biodegradable plastic manufactured may be deteriorated.

In a preferred embodiment of the present invention, the plasticizer may be included in an amount of 20 wt % to 35 wt % based on the total weight of the thermoplastic starch composition.

The plasticizer may be one or more selected from a short-chain lipid-based polyhydric alcohol such as glycerol, a polyalcohol such as polyethylene glycol (weight average molecular weight of 400 g/mol to 4,000 g/mol), a citric acid or an ester compound thereof, urea, and a hexose compound. An example of the hexose compound is sorbitol. However, the plasticizer is not necessarily selected from the above examples, and may be selected from a polyhydric alcohol or a water soluble compound having biodegradability. Preferably, glycerol may be used as the plasticizer, and specifically, a plasticizer having high compatibility may be selected and used depending on the type of the starch. Depending on the type of the plasticizer, the tensile strength and elongation of a manufactured biodegradable plastic containing thermoplastic starch may be flexibly controlled, and functionality such as hydrophobicity may be imparted thereto, so that the plasticizer may be selected according to the purpose.

### Additive

The additive may be added for functionality, such as strengthening physical properties of a biodegradable plastic or preventing long-term deterioration in the physical properties. Specifically, the additive may be included in an amount of 15 wt % or less based on the total weight of the thermoplastic starch composition. If the content of the additive is greater than 15 wt % based on the total weight of the thermoplastic starch composition, processability, biodegradability, mechanical properties, and the like of the biodegradable plastic may be degraded.

In a preferred embodiment of the present invention, the additive may include a filler, an antioxidant, and natural substance-derived polymers other than the starch.

The filler may preferably be talc, calcium carbonate (CaCO₃), or titanium dioxide (TiO₂). The filler serves to prevent the deterioration in physical properties of the biodegradable plastic and reduce costs. In addition, since the above-described filler is included, the color of the biodegradable plastic may become white to improve dyeability. The filler may preferably be included in an amount of 15 wt % or less based on the total weight of the thermoplastic starch composition. If the content of the filler is greater than 15 wt %, mechanical properties of a manufactured biodegradable plastic may be deteriorated.

In addition, the additive may preferably further include an antioxidant. The antioxidant may be added to prevent the starch of the biodegradable plastic from being carbonized and discolored during a high-temperature process, or polymers of the starch from being decomposed, thereby reducing the molecular weight. Specifically, the antioxidant reacts with free radicals in the biodegradable plastic, which are generated by heat or shear, to suppress the oxidation and prevent the discoloration of the starch. The antioxidant may preferably include a primary antioxidant and a secondary antioxidant.

The primary antioxidant is a heat stabilizer, and instead of the starch polymers, the primary antioxidant reacts with the free radicals generated by heat, shear, or the like, thereby preventing the oxidation of the starch, and a radical initiator may be used as the primary antioxidant. Preferably, a phenolic or amine-based radical initiator may be used.

In addition, the secondary antioxidant functions to decompose radicals generated by heat or shear, specifically peroxides, to prevent further oxidation of the starch. As the secondary antioxidant, one or more selected from sulfur-based and phosphorus-based antioxidants may be used.

The thermoplastic starch composition of the present invention uses both the primary antioxidant and the secondary antioxidant, and thus, may more effectively prevent the oxidation of the starch by heat or shear.

The antioxidant may be included in an amount of 2,000 ppm or less based on the total weight of the thermoplastic starch composition. Specifically, the primary antioxidant may be included in an amount of 1,000 ppm or less, and the secondary antioxidant may be included in an amount of 1,000 ppm or less. Since the secondary antioxidant functions to prevent further oxidation, it is not beneficial that the content thereof is greater than the content of the primary antioxidant, and if the content of the primary antioxidant is greater than 1,000 ppm, mechanical properties of the biodegradable plastic may be degraded and the appearance thereof may become poor.

In addition, the additive may further include natural substance-derived polymers other than the starch. The natural substance-derived polymers are introduced to increase compatibility with the biodegradable polymer resin or to improve mechanical properties of the biodegradable plastic, and are derived from natural substances, and thus, may change physical properties of the biodegradable plastic containing the thermoplastic starch composition while minimizing a burden on the environment.

The natural substance-derived polymers may include, but are not limited thereto, one or more polymers selected from the group consisting of natural substance-derived polymers other than acid, carrageenan, maltodextrin, starch, such as alginic cyclodextrin, carboxymethyl cellulose, pectin, chitin, xanthan gum, casein, and whey, and may be selected from natural substance-derived polysaccharides.

According to a preferred embodiment of the present invention, the term “thermoplastic starch composition” refers to a composition in which starch, a plasticizer, and selectively, an additive are mixed using a mixer, and thus, are physically mixed. In addition, the term “thermoplastic starch pellet” refers to the above-described thermoplastic starch composition extruded using a twin-screw extruder and then cut into a pellet form.

### 2. Biodegradable Polymer Resin

### Biodegradable Polymer Resin

In a preferred embodiment of the present invention, the biodegradable polymer resin may include one or more selected from the group consisting of polylactic acid (PLA), polybutylene adipate terephthalate (PBAT), polybutylene succinate (PBS), and polyhydroxy alkanoates (PHAs).

Here, the polyhydroxy alkanoate may be derived from a hydroxy alkanoate having 3 to 8 carbon atoms, that is, an alkanoate ester such as hydroxy propionate, hydroxy butanoate, hydroxy pentanoate, hydroxy hexanoate, hydroxy heptanoate, and hydroxy octanoate.

Among the above, the polylactic acid is preferably added to the biodegradable plastic in order to manufacture a molded article for use that requires strength, such as a vessel or an injection molded article. In addition, the polylactic acid is advantageous compared to other resins in terms of manufacturing cost, and has excellent compatibility with the thermoplastic starch composition, and thus, is a desirable raw material.

The biodegradable plastic using the polybutylene adipate terephthalate may implement excellent elongation, so that the polybutylene adipate terephthalate may be selected as a biodegradable polymer resin which is a main raw material for manufacturing a biodegradable film. In order to improve the elastic modulus of the biodegradable film, polylactic acid or polybutylene succinate may be added in addition to the polybutylene adipate terephthalate.

### Compatibilizer

In a preferred embodiment of the present invention, the biodegradable polymer resin may further include, a as compatibilizer, one or more biodegradable polymer resins selected from polylactic acid, polybutylene adipate terephthalate, polybutylene succinate, and polyhydroxyalkanoate, which are grafted with a cyclic unsaturated anhydride or an unsaturated multifunctional carboxylic acid.

The compatibilizer serves to improve compatibility between the biodegradable polymer resin and the thermoplastic starch composition, the cyclic unsaturated anhydride may preferably be succinic anhydride, and the unsaturated polyfunctional carboxylic acid may be succinic acid.

The biodegradable polymer resin may preferably include the compatibilizer in an amount of 1 wt % to 5 wt %. If the content of the compatibilizer is less than 1 wt %, the compatibility between the thermoplastic starch composition and the biodegradable polymer resin may decrease, so that the quality of prepared biodegradable polymers may become poor, and when the content of the compatibilizer is greater than 5 wt %, physical properties of prepared biodegradable polymers may be affected thereby, so that mechanical properties and the like may be degraded.

### 3. Biodegradable Plastic Article

The present invention also provides a biodegradable plastic article manufactured by molding the above-described biodegradable plastic.

The molding may preferably performed by extrusion or injection and molding. The extrusion is a molding method of continuously drawing a predetermined shape from an extruder, and the injection and molding refers to injecting an extruded molten plastic into a cast (or mold) to mold the same into a single product having a predetermined shape. Specifically, the biodegradable plastic article may be manufactured by molding the biodegradable plastic, which is manufactured in the form of pellets or chips, through a post-processing process.

In a preferred embodiment of the present invention, the biodegradable plastic article may be a biodegradable film or plastic injection molded body.

Since the flexibility and elongation are importance physical properties of the biodegradable film, it is preferable to select polybutylene adipate terephthalate as the biodegradable polymer resin. The plastic injection molded body requires high strength, and may be, for example, a container, a structural body, and the like. In a biodegradable plastic to be used for the plastic injection molded body, polylactic acid is preferably selected as the biodegradable polymer resin. In each case, a small amount of other biodegradable polymers may be added for functionality.

Hereinafter, embodiments of the present invention will be described in detail so that those skilled in the art to which the present invention belongs may easily implement the present invention, but this is merely an example, and the scope of rights of the present invention is not limited by the following contents.

### EXAMPLES

### Example 1: Biodegradable Plastic-Thermoplastic Starch Composition and Polylactic Acid

67 wt % of corn starch was mixed with 33 wt % of glycerin as a plasticizer, and 10 wt % of calcium carbonate and 2,000 ppm of an antioxidant based on the weight of the mixture were further mixed therewith. The mixture was introduced into a twin-screw extruder to be primarily extruded, molded, and then cut into a suitable size to prepare thermoplastic starch pellets.

In addition, a biodegradable polymer resin was obtained by mixing a polylactic acid (weight average molecular weight: 150,000 g/mol) resin with 5 wt % of maleic acid-grafted polylactic acid as a compatibilizer. The biodegradable polymer resin containing the polylactic acid and the thermoplastic starch pellets were simultaneously injected into a twin-screw extruder, and the twin-screw extruder was operated to perform compounding, secondary extrusion, and molding at a temperature of about 170° C. to obtain a biodegradable plastic.

The mixing weight ratio of the thermoplastic starch pellets and the biodegradable polymer resin was controlled as shown in Example 1A to Example 1F of Table 1 below.

In Table 1, the TPS content indicates the weight ratio of the thermoplastic starch composition added to the biodegradable plastic in the form of the thermoplastic starch pellets.

### Example 2: Biodegradable Plastic-Thermoplastic Starch Composition and Polybutylene Adipate Terephthalate

The same procedure as in Example 1 was performed, except that the biodegradable polymer resin was changed from polylactic acid to polybutylene adipate terephthalate, and the compatibilizer was also changed to maleic acid-grafted polybutylene adipate terephthalate, wherein the compatibilizer was included in an amount of 5 wt % in the biodegradable polymer resin in the same manner as in Example 1.

In addition, the weight ratio between the TPS and the biodegradable polymer resin was as shown in Example 2A to Example 2F of Table 1 below.

### Example 3: Biodegradable Plastic-Thermoplastic Starch Composition, Polybutylene Adipate Terephthalate, and Polylactic Acid

The same procedure as in Example 1 was performed, except that the biodegradable polymer resin was changed to a mixture of polylactic acid and polybutylene adipate terephthalate, and the compatibilizer was also changed to a mixture of maleic acid-grafted polybutylene adipate terephthalate and maleic acid-grafted polylactic acid, wherein the a maleic acid compatibilizer was included in an amount of 5 wt % in the biodegradable polymer resin in the same manner as in Example 1 and Example 2.

The weight ratio of TPS, PLA, and PBAT included in the biodegradable plastic was as shown in Example 3A to Example 3F of Table 1 below.

### Comparative Example 1: Biodegradable Plastic-Thermoplastic Starch Composition

The same procedure as in Example 1 was performed, except that only the thermoplastic starch composition was extruded and molded without using a biodegradable polymer resin to manufacture a biodegradable plastic.

### Comparative Example 2: Biodegradable Plastic-Polylactic Acid

The same procedure as in Example 1 was performed, except that only the polylactic acid was extruded and molded without the TPS and the maleic acid-grafted polylactic acid, which is a compatibilizer, to manufacture a biodegradable plastic according to the prior art.

| | | | Tensile | | Elastic | | |
|---|---|---|---|---|---|---|---|
| | Composition | FC/V-X_{c}- | strength | Elongation | modulus | MFI | Biodegradation |
| | (wt %) | X_{c}/(FC/V) | (MPa) | (%) | (MPa) | (g/min) | (%) |
| Example | TPS 5 | 0.008-1.16- | 68.78 | 1.69 | 2838.01 | 9.83 | 65 |
| 1a | PLA 95 | 145.0 | | | | | |
| Example | TPS 10 | 0.014-2.48- | 61.48 | 3.74 | 2825.27 | 4.62 | 72 |
| 1b | PLA 90 | 172.4 | | | | | |
| Example | TPS 20 | 0.017-3.39- | 46.77 | 4.37 | 2333.93 | 4.25 | 79 |
| 1c | PLA 80 | 195.7 | | | | | |
| Example | TPS | 0.026-6.15- | 37.45 | 4.74 | 1787.55 | 3.86 | 84 |
| 1d | 30PLA | 232.8 | | | | | |
| | 70 | | | | | | |
| Example | TPS 50 | 0.056- | 23.02 | 6.94 | 970.25 | 2.77 | 92 |
| 1e | PLA 50 | 155.5 8.64- | | | | | |
| Example | TPS 70 | 0.061 11.17- | 15.85 | 7.18 | 656.89 | 0.87 | 96 |
| 1f | PLA 30 | 183.1 | | | | | |
| Example | TPS | 0.068-13.63- | 11.22 | 7.41 | 570.38 | 0.33 | 98 |
| 1g | 80PLA | 200.4 | | | | | |
| | 20 | | | | | | |
| Example | TPS | 0.012-3.34- | 33.61 | 886.34 | 115.24 | 23.84 | 76 |
| 2a | 5PBAT | 278.3 | | | | | |
| | 95 | | | | | | |
| Example | TPS 10 | 0.034-15.01- | 31.05 | 832.88 | 110.70 | 15.2 | 83 |
| 2b | PBAT | 444.1 | | | | | |
| | 90 | | | | | | |
| Example | TPS 20 | 0.033-18.37- | 32.15 | 937.45 | 102.73 | 14.3 | 86 |
| 2c | PBAT | 559.5 | | | | | |
| | 80 | | | | | | |
| Example | TPS | 0.030-22.76 | 26.81 | 810.06 | 89.32 | 7.61 | 94 |
| 2d | 30PBAT | 748.7 | | | | | |
| | 70 | | | | | | |
| Example | TPS 50 | 0.042-24.30- | 18.56 | 624.25 | 78.61 | 4.43 | 97 |
| 2e | PBAT | 585.1 | | | | | |
| | 50 | | | | | | |
| Example | TPS 70 | 0.038 29.61- | 13.28 | 596.36 | 67.98 | 3.94 | 98 |
| 2f | PBAT | 779.2 | | | | | |
| | 30 | | | | | | |
| Example | TPS | 0.047-33.04- | 12.06 | 534.48 | 62.71 | 2.35 | 98 |
| 2g | 80PBAT | 703.0 | | | | | |
| | 20 | | | | | | |
| Example | TPS 5 | 0.001 0.93- | 57.62 | 159.32 | 2571.41 | 5.58 | 73 |
| 3a | PLA 90 | 931.9 | | | | | |
| | PBAT 5 | | | | | | |
| Example | TPS 20 | 0.011 8.21- | 33.91 | 156.64 | 1607.1 | 7.92 | 82 |
| 3b | PLA 60 | 718.1 | | | | | |
| | PBAT | | | | | | |
| | 20 | | | | | | |
| Example | TPS | 0.026-15.45 | 27.89 | 186.15 | 1050.06 | 4.49 | 88 |
| 3c | 20PLA | 590.5 | | | | | |
| | 40 | | | | | | |
| | PBAT | | | | | | |
| | 40 | | | | | | |
| Example | TPS | 0.030-16.91- | 15.79 | 362.07 | 636.58 | 4.97 | 89 |
| 3d | 20PLA | 559.6 | | | | | |
| | 20 | | | | | | |
| | PBAT | | | | | | |
| | 60 | | | | | | |
| Example | TPS | 0.029 17.54- | 17.38 | 490.07 | 162.51 | 4.56 | 92 |
| 3e | 30PLA | 612.0 | | | | | |
| | 10 | | | | | | |
| | PBAT | | | | | | |
| | 60 | | | | | | |
| Example | TPS 30 | 0.030-17.15 | 21.39 | 217.27 | 112.31 | 4.09 | 93 |
| 3f | PLA 20 | 562.42 | | | | | |
| | PBAT | | | | | | |
| | 50 | | | | | | |
| Example | TPS 70 | 0.053-17.36- | 13.03 | 338.16 | 151.36 | 3.63 | 96 |
| 3g | PLA 15 | 327.6 | | | | | |
| | PBAT | | | | | | |
| | 15 | | | | | | |
| Example | TPS | 0.062 19.02- | 10.37 | 259.06 | 78.90 | 2.63 | 98 |
| 3h | 80PLA | 306.8 | | | | | |
| | 10 | | | | | | |
| | PBAT | | | | | | |
| | 10 | | | | | | |
| Comparative | TPS | 0.068-13.87- | 5.87 | 87.73 | 54.00 | 56.86 | 99 |
| Example | 100 | 204.25 | | | | | |
| 1 | | | | | | | |
| Comparative | PLA | 0.001-0.89- | 72.40 | 1.44 | 119.78 | 26.96 | 60 |
| Example | 100 | 883.7 | | | | | |
| 2 | | | | | | | |

### EXPERIMENTAL EXAMPLES

### Experimental Example 1: Thermogravimetric Analysis

About 10 mg of a sample of the biodegradable plastic manufactured according to each of Examples and Comparative shown in Table 1 was taken and analyzed in a 5 Examples thermogravimetric analyzer as follows. The test method was based on ASTM D7582-15.

Step 1: After a nitrogen environment was set, about 10 mg of each sample was loaded into a thermogravimetric analyzer and heated to about 105° C. at a rate of 5° C./min, and when the temperature reached 105° C., an isothermal state was maintained for about 10 minutes to remove moisture by evaporation.

Step 2: When the moisture was sufficiently removed and the weight no longer changed, the temperature was raised again at a rate of about 10° C./min while maintaining the nitrogen environment until the temperature of the sample reached 800° C. When the temperature reached 800° C., the isothermal temperature was maintained for about 10 minutes while maintaining the nitrogen atmosphere to remove volatile components.

Step 3: When the volatile components were sufficiently removed by leaving the sample to stand for about 10 minutes, the nitrogen atmosphere was switched to an air atmosphere while maintaining the temperature to allow all the remaining carbon components to burn.

The mass lost in Step 2 was set to a volatile matter V, which is the mass of the volatile components, and the mass lost in Step 3 was set to a fix carbon FC, and calculated FC/V values are respectively shown in Table 1 above.

### Experimental Example 2: XRD Spectrum Analysis Measurement of Crystallinity

In addition, an X-ray diffraction experiment was performed on each sample to obtain a spectrum thereof. Since the obtained XRD spectrum includes many noise signals, a background signal was removed using a data processing program by Rigaku Company.

An area ratio (%) of a crystal peak signal to the total area of a graph in an XRD spectrum corrected by using the above data program was calculated to obtain a crystallinity X_{c} value. The obtained X_{c} values are respectively shown in Table 1 above.

### Experimental Example 3: Measurement of Tensile Strength, Elongation, and Elastic Modulus

The biodegradable plastics according to Examples and Comparative Examples of Table 1 were respectively molded and manufactured into dumbbell-shaped specimens in accordance with criteria of ASTM D638. Each specimen was tensioned with a tensile strength and elongation measurement tester until the specimen broke, and the elastic modulus during an elastic behavior and the tensile strength and elongation at the time when the specimen broke were respectively measured and are shown in Table 1 above.

### Experimental Example 4: Measurement of Melt Flow Index

The melt flow index of the biodegradable plastic according to each of Examples and Comparative Examples of Table 1 was measured based on criteria of ISO 1133 or ASTM D1238. Specifically, each plastic molded into the form of pellets or granules was introduced into a cylinder of a melt flow index measuring device (Hanatek MFI tester) and heated to a temperature of about 180° C. to apply a load of 2.16 g to the cylinder, thereby measuring the weight of a resin discharged through a die (a diameter about 2.09 mm) to calculate the melt flow index (MFI). The values are respectively shown in Table 1 above.

### Experimental Example 5: Evaluation of Biodegradability

The biodegradability of the biodegradable plastic according to each of Examples and Comparative Examples of Table 1 was evaluated by the following evaluation method.

The biodegradability of each specimen of the biodegradable plastics was measured in accordance with criteria of KS M ISO 14855-1. Specifically, each sample was placed under an industrial composting condition and allowed to biodegrade for 45 days to measure the amount of carbon dioxide produced from each sample. The percentage of a measured amount of produced carbon dioxide to a theoretical amount of produced carbon dioxide is shown as aerobic biodegradability (%) in Table 1 above.

Referring to Table 1 above, it can be seen that the biodegradable plastic of Comparative Example 1 manufactured using only the thermoplastic starch composition is very low in the tensile strength and the elastic modulus, but is excessively high in the melt flow index. Therefore, it can be seen that Comparative Example 1 is unsuitable for use as a structural body utilizing mechanical properties. Comparative Example 2, which used only the PLA and excluded the thermoplastic starch composition, was very low in the FC/V value, indicating insufficient volatile components, so that it can be seen that the melt flow index was also excessive. In addition, due to the low elongation thereof, the biodegradable plastic of Comparative Example 2 was found to have unsuitable physical properties for use as a film.

Comparing Examples 1A to 1F, 2A to 2F, and 3A to 3G, it can be seen that Examples using PLA have a higher tensile strength and a higher elastic modulus, but have a lower elongation than Examples using PBAT, and thus, are suitable for use in applications that require strength, instead of a biodegradable film. On the contrary, it can be seen that Examples using PBAT are high in the elongation but are relatively low in the tensile strength and the elastic modulus, and thus, have physical properties suitable for use in a biodegradable film that requires flexibility.

Referring to Examples 1A, 1F, 2A, 2F, 3A, and 3G, it can be seen that in Examples 1A, 2A, and 3A in which the weight ratio of the thermoplastic starch composition was low, the crystallinity of the plastic was significantly low or the melt flow index was excessively high, resulting in poor processability or inferior mechanical properties. On the contrary, in Examples 1F, 2F, and 3G in which the weight ratio of the thermoplastic starch composition was excessive, the crystallinity of the plastic was excessively high, and the mechanical properties and the elastic modulus were low. In addition, it can be seen that the biodegradability of the biodegradable plastic increases in proportion as the weight ratio of the thermoplastic starch composition increases.

1. A biodegradable plastic comprising
a thermoplastic starch composition and a biodegradable polymer resin, and
satisfying Relation Equation 1 below:
$$0.01 \leq FC / V \leq 0.06 \qquad [ Relation Equation 1 ]$$
wherein in Relation Equation 1 above, FC/V is obtained from FC and V values obtained in accordance with Measurement Method 1 below:
[Measurement Method 1]
a sample of the biodegradable plastic is heated to 105° C. in a nitrogen atmosphere by a thermogravimetric analysis (TGA) method in accordance with criteria of ASTM D 7582-15, followed by maintaining the isothermal temperature for 10 minutes (Step 1), the sample is heated for the second time to 800° C. while the nitrogen atmosphere is maintained, followed by maintaining the isothermal temperature at 800° C. for 10 minutes (Step 2), and then the nitrogen atmosphere is switched to an air atmosphere to burn the remaining biodegradable plastic sample (Step 3), wherein when the mass loss in each step is measured, the mass loss at Step 2 is referred to as V, and the mass loss at Step 3 is referred to as FC.

2. The biodegradable plastic of claim 1, wherein the biodegradable plastic comprises a thermoplastic starch composition in an amount of 10 wt % to 75 wt %.

3. The biodegradable plastic of claim 2, wherein the thermoplastic starch composition comprises starch, a plasticizer, and an additive.

4. The biodegradable plastic of claim 3, wherein the additive comprises a filler, an antioxidant, and natural substance-derived polymers other than the starch.

5. The biodegradable plastic of claim 1, wherein the biodegradable polymer resin comprises one or more selected from the group consisting of polylactic acid (PLA), polybutylene adipate terephthalate (PBAT), polybutylene succinate (PBS), and polyhydroxy alkanoates (PHAs).

6. The biodegradable plastic of claim 1, wherein the biodegradable polymer resin further comprises, as a compatibilizer, one or more biodegradable polymer resins selected from PLA, PBAT, PBS, and PHAs, which are grafted with a cyclic unsaturated anhydride or an unsaturated multifunctional carboxylic acid.

7. The biodegradable plastic of claim 1, wherein the biodegradable plastic further satisfies Relation Equations 2 and 3 below:
$$1. ( \% ) \leq {X}_{c} \leq 30. ( \% ) \qquad [ Relation Equation 2 ]$$
$$150 \leq {X}_{c} / ( FC / V ) \leq 750 \qquad [ Relation Equation 3 ]$$
wherein in Relation Equations 2 and 3 above, FC/V is the same as defined in Relation Equation 1 above, and X_{c} represents crystallinity of the biodegradable plastic.

8. A biodegradable plastic article manufactured by molding the biodegradable plastic according to claim 1.

9. The biodegradable plastic article of claim 8, wherein the biodegradable plastic article is a biodegradable film.

10. The biodegradable plastic article of claim 8, wherein the biodegradable plastic article is a plastic injection molded body.
